(19) United States
(12) Patent Application Publication
(10) Pub. No.: US 2021/0350353 A1
(43) Pub. Date: Nov. 11, 2021

(54) SYSTEM AND A METHOD FOR PAYMENTS ON AN IN-VEHICLE COMPUTER SYSTEMS

(71) Applicant: DENSO International America, Inc., Southfield, MI (US)

(72) Inventors: Vikas UPMANUE, Novi, MI (US); Te-Ping KANG, Ann Arbor, MI (US); Brittany SCHOENOW, Merrill, MI (US); Bilal ALASRY, Dearborn, MI (US); Doua VANG, Davisburg, MI (US); Yu ZHANG, Farmington Hills, MI (US)

(21) Appl. No.: 17/218,707

(22) Filed: Mar. 31, 2021

Related U.S. Application Data
(60) Provisional application No. 63/021,352, filed on May 7, 2020.

(51) Int. Cl. G06Q 20/32; H04W 4/44; G06Q 20/40; B60Q 5/00; H04W 4/48

(52) U.S. Cl. CPC G06Q 20/325; H04W 4/44; G06Q 20/3224; G06Q 20/3276; B60Q 5/005; H04W 4/48; G06Q 20/4015

(57) ABSTRACT

A computer-implemented method for utilizing vehicle connectivity to facilitate payment account transactions, the method comprising one or more wireless transceivers in communication with a remote server and mobile device, a processor in communication with the wireless transceiver and transceiver, wherein the processor is programmed to identify a transaction option utilizing data sent to the vehicle computer system, wherein the data is associated with a point of interest (POI), in response to identifying the transaction option, outputting a prompt on a vehicle display, the prompt including the transaction option, and sending information regarding the transaction option to the remote server.

### CROSS-REFERENCE TO RELATED APPLICATIONS

This application claims the benefit of U.S. provisional application Ser. No. 63/021,352 filed May 7, 2020, the disclosure of which is hereby incorporated in its entirety by reference herein.

### TECHNICAL FIELD

The present disclosure relates to vehicle computer systems.

### BACKGROUND

Digital payments and electronic transactions are becoming increasingly popular. A consumer may use a form of digital payment to conduct transactions (e.g., purchase items or services) at various locations, such as at a curbside pickup, grocery pickup, car wash, gas station, valet parking, etc. Some transactions may be pre-paid at the time the order is placed. When it comes time to picking up the order, the consumer may want to give a gratuity to the person providing the service. However, the consumer may not have the necessary form of payment (e.g., cash or change) for the gratuity and the gratuity is missed. Additionally or alternatively, it may be challenging to give a gratuity when the weather in inclement, such as raining, snowing, cold, windy, etc. because the consumer may not want to subject themselves to the inclement weather.

This concept provides a digital way of giving a gratuity from a vehicle and clearly communicating a gesture of gratitude to the person providing the service.

### SUMMARY

According to one embodiment, a computer-implemented method for utilizing vehicle connectivity to facilitate payment account transactions. The method includes one or more wireless transceivers in communication with a remote server and mobile device, a processor in communication with the wireless transceiver and transceiver. The processor is programmed to identify a transaction option utilizing data sent to the vehicle computer system, wherein the data is associated with a point of interest (POI), in response to identifying the transaction option, outputting a prompt on a vehicle display, the prompt including the transaction option, and sending information regarding the transaction option to the remote server.

According to a second embodiment, a vehicle computer system of a vehicle includes one or more wireless transceivers of the vehicle in communication with a remote server and mobile device, and a processor in communication with the wireless transceiver. The processor is programmed to in response to one or more sensors of the vehicle identifying information, identify a transaction option utilizing data sent to the vehicle computer system, wherein the data is associated with a point of interest (POI), and output a prompt on a vehicle display, the prompt including the transaction option, and send information regarding the transaction option to the remote server.

According to a third embodiment, a vehicle computer system of a vehicle includes one or more wireless transceivers in communication with a remote server and mobile device, and a processor in communication with the wireless transceiver and transceiver. The processor is programmed to identify data initializing transactions sent to the vehicle computer system from the remote server, and output a prompt including a transaction in response data associated with a point of interest (POI) and GPS location associated with the vehicle computer system, wherein the prompt to the transaction offers a tipping option, and sending the transaction to the server.

### BRIEF DESCRIPTION OF THE DRAWINGS

FIG. 1 discloses an embodiment of an illustrative vehicle multimedia system that may include a navigation apparatus and a data center.

FIG. 2 discloses a gratuity payment system.

FIG. 3 illustrates a flowchart depicting an example method of a digital payment transaction for adding a gratuity.

FIG. 4 discloses an example prompt utilizing the gratuity payment system.

FIG. 5 discloses an example interface of the gratuity payment system.

FIG. 6 discloses an example flow chart of the gratuity payment system with an alert upon conclusion of a transaction.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure relates to a gratuity payment system that allows a consumer or user to give a gratuity to a person providing a service from a vehicle. The gratuity payment system may keep a transaction that has already been pre-paid open, allowing the consumer or user to add a gratuity from the vehicle. An external notification may be utilized to inform the person providing the service that a gratuity has been given to them and to inform them of the kind gesture.

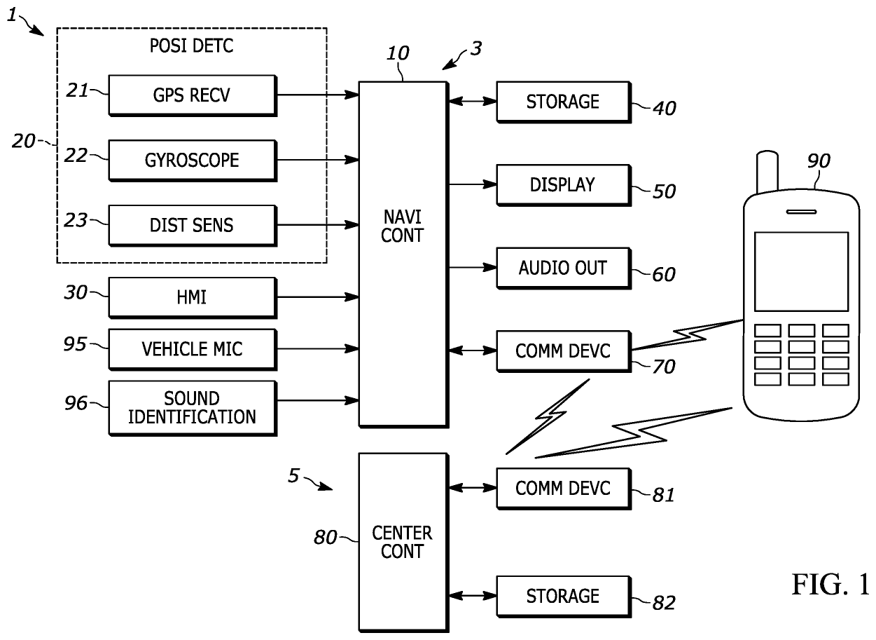

As shown in FIG. 1, a vehicle system 1 includes a navigation apparatus 3 and a data center 5. The navigation apparatus 3 may be equipped in a vehicle and may include a navigation controller (NAVI CONT) 10 or processor. The navigation apparatus may be a portable terminal, such as a smart phone having a navigation function, other than a device equipped to a vehicle. The navigation apparatus may also be an off-board server or system that processes directions and maneuvers off-board that are to be sent to the vehicle. The route may be calculated using a remote service place and pushed into the vehicle storage. The navigation could be played as audio messages or visual indications (e.g. icons). Local position detectors (either on-board or off-board) may be utilized to match car's position to the route info. The navigation controller 10 may include a microcomputer, which has a central processing unit (CPU), a read only memory (ROM), a random-access memory (RAM), an input/output (I/O) interface and a bus line for coupling the CPU, the ROM, the RAM and the I/O interface. The navigation controller 10 may include a position detector (POSI DETC) 20, a user interface or human machine interface (HMI) 30, a storage 40, a display screen (DISPLAY) 50, an audio output device (AUDIO OUT) 60, and a communication device (COMM DEVC) 70. The position detector 20 may detect a present position of the vehicle. The user interface 30 may be used for inputting a command from a user to the navigation apparatus 3 or vehicle system 1. The storage 40 may store map data. The display screen 50 may display a map and various information to the user. The audio output device 60 may output audio guidance and sounds to occupants of the vehicle. The communication device 70 of the navigation apparatus 3 may communicate with an off-board server 5 or data center 5. Furthermore, the communication device 70 (or another communication device, such as a wireless transceiver as a Bluetooth transceiver), may be utilized to communication with a mobile device 90, such as a mobile phone. The mobile device 90 may be utilized for handsfree communication or other capabilities based on interoperability with the vehicle system 1.

The position detector 20 may receive signals transmitted from satellites for a global positioning system (GPS). The position detector 20 may include a GPS receiver (GPS RECV) 21, a gyroscope (DIST SENS) 22, and a distance sensor (DIST SENS) 23. The GPS receiver 21 may detect a position coordinate and an altitude of the present position of the vehicle. The gyroscope 22 outputs a detection signal corresponding to an angular velocity of a rotational motion applied to the vehicle. The distance sensor 23 outputs a traveling distance of the vehicle. The navigation controller 10 calculates the present position, a direction, and a velocity of the vehicle based on signals output from the GPS receiver 21, the gyroscope 22, and the distance sensor 23. Further, the present position may be calculated in various methods based on the output signal from the GPS receiver 21. For example, a single point positioning method or a relative positioning method may be used to calculate the present position of the vehicle.

The HMI 30 or user interface 30 includes a touch panel and may include mechanical key switches. The touch panel is integrally set with the display screen 50 on the display screen or located away from the display such as in front of an arm rest. The mechanical key switches are arranged around the display screen 50. When the navigation apparatus 3 provides a remote-control function, operation switches for the remote-control function are arranged in the HMI 30. The HMI 30 may also include a voice recognition system that utilizes voice prompts to operate various vehicle functions. The HMI 30 may also include a haptic device or similar device that allows a user to control and operate the system. The HMI 30 may also include a voice recognition system, remote touchpad, or utilize a stylus pen.

The storage 40, in which the applications and map data is stored, inputs various data included in the map data to the navigation controller 10. The various data includes road data, facility data, point-of-interest (POI) data, address book data, and guidance data. The road data is indicative of a road connection status, and includes node data, which indicates a predetermined position such as an intersection, and link data, which indicates a link that connects adjacent nodes. The facility data is indicative of a facility on the map. The guidance data is used for route guidance. Address book data may be utilized to store custom contacts, locations, and other information (e.g. home or work). POI data may be utilized to identify a POI'S location, contact information, category information, review (e.g. Zagat or Yelp) information, etc. Examples of a POI may be a McDonald's under the category of a fast-food restaurant; Starbuck's under coffee shop, a Holiday Inn under the category of hotel, etc. Other POI examples may include, hospitals, dealerships, police stations, cleaners, etc. POIs may be independent business or corporate businesses. The storage 40 may be configured to be rewritable in order to update various applications, software, operating system, and the user interface of the vehicle. For example, a hard disk drive (HDD) and a flash memory may be used as the storage 40.

The display screen 50 may be a color display apparatus having a display surface such as a liquid crystal display, or a heads-up display (HUD). The display screen 50 displays various display windows according to video signal transmitted from the navigation controller 10. Specifically, the display screen 50 displays a map image, a guidance route from a start point to a destination, a mark indicating the present position of the vehicle, and other guidance information. The display screen 50 may also be a touch screen interface that allows for a user to interact with an operating system, software, or other applications via interaction with the screen. The audio output device 60 may output audible prompts and various audio information to the user. With above-described configuration, the route guidance can be performed by displaying viewable information on the display screen 50 and outputting audible information with the audio output device 60.

The communication device 70 may communicate data with the “cloud,” for example, a data center 5. Specifically, the navigation apparatus 3 may be wirelessly coupled to a network via the communication device 70 so that the navigation apparatus 3 performs the data communication with the data center 5. The communication device 70 may be an embedded telematics module or may be a Bluetooth transceiver paired with mobile device 90 utilized to connect to remote servers or the “cloud.” The communication device 70 may be both a Bluetooth communication or another form of wireless (or wired) communication. The “cloud” may also be utilized to process voice recognition commands. Thus, the “cloud” may store a voice recognition engine and be utilized to communicate voice commands and associated responses with the vehicle.

The server 5, which is remote from the vehicle, mainly includes a data center controller (CENTER CONT) 80. Similar to the navigation controller 10, the data center controller 80 mainly includes a well-known microcomputer, which has a CPU, a ROM, a RAM, an input/output interface and a bus line for coupling the CPU, the ROM, the RAM and the I/O interface. The data center controller 80 includes a communication device (COMM DEVC) 81, a first storage (FIR STORAGE) 82. The communication device 81 of the data center 5 performs the data communication with the navigation apparatus 3. Specifically, the data center 5 is wirelessly coupled to the network via the communication device 81 so that the data center 5 performs the data communication with the navigation apparatus 3.

The system may be equipped with a vehicle mic 95 or sound identification device 96. The sound identification device 96 determines a probability that the sound data corresponds to a pre-defined sound based on the subset of temporal parameters. In the illustrative embodiment, the sound identification device 96 applies an algorithm (e.g. trained deep-neural-network or other machine learning network) to initiate a voice recognition session. In the illustrative embodiment, the algorithm takes a number of inputs corresponding to the number of temporal parameters. Each acoustic feature vector may include a number of features and temporal parameters that are determined for each acoustic feature. Of course, in other embodiments, the number of parameters may vary. The deep-neural-network algorithm of the illustrative sound identification device 96 may have previously been trained using machine learning in order to accurately determine if the sound data matches a pre-defined command. The deep-neural-network algorithm may employ a softmax layer, backpropagation, and cross-entropy optimization as part of the training. This training may include supplying samples of sounds that match the pre-defined sound and samples of sounds that do not match the pre-defined sound, such as sounds similar to expected background noise. For example, if the pre-defined sound is an infant crying, the algorithm may be provided with a number of samples of infants crying as well as sounds similar to expected background noise such as adult conversation, road traffic noise, and other vehicle sounds.

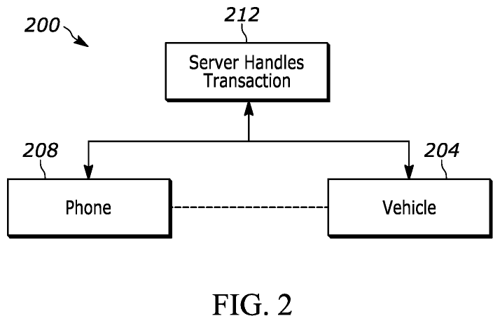

FIG. 2 illustrates a gratuity payment system 200. The gratuity payment system 200 includes a vehicle 204, mobile device 208, and remote sever 212. The vehicle 204 may include any type of vehicle, such as a passenger vehicle, commercial vehicle, motorcycle, sport utility vehicle, minivan, sedan, watercraft, off-road vehicle, etc. The vehicle 204 may include a display, such as an instrument cluster, navigation display, human-machine interface (HMI), etc. The vehicle 204 may include additional components, such as a global positions system (GPS), transceiver, camera, processor, memory, one or more sensors, etc.

The mobile device 208 may include any type of device, such as a phone, wearable device, tablet, etc. The mobile device 208 may belong to a consumer or user. In various implementations, the consumer or user may be a driver or passenger of the vehicle 208. The mobile device 208 may include additional components, such as a GPS, transceiver, camera, processor, memory, one or more sensors, display, etc. The mobile device 208 may be connected to the vehicle 204 using, for example, Bluetooth protocol.

The remote server 212 (e.g., cloud) may manage a payment transaction, such as a digital payment transaction. For example, when a consumer makes a purchase using a digital form of payment, the remote server 212 may determine whether to keep the transaction open to allow for a gratuity to be added or to close the transaction without a gratuity, as discussed further below. The remote server 212 may be wirelessly coupled to a network to allow for data communication to the vehicle 204 and/or mobile device 208. The remote server 212 may communicate to the network by utilizing any wired or wireless communication protocol, such as Long-Term Evolution (LTE), wireless fidelity (Wi-Fi), Bluetooth, WiGig, GPS, global navigation satellite system (GNSS), near field communication (NFC), etc. The remote server 212 may include additional components, such as a transceiver, processor, memory, etc.

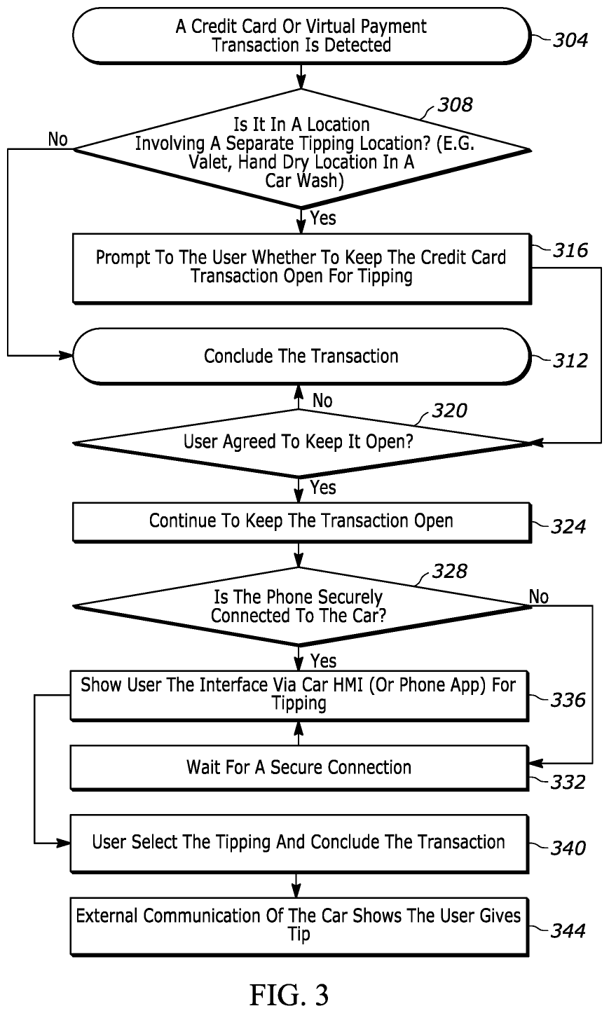

FIG. 3 illustrates a flowchart depicting an example method of a digital payment transaction for adding a gratuity. At 304, the remote server may determine that a digital payment transaction is detected. For example, the digital payment transaction may be detected when a digital form of payment is utilized, such as a credit card, virtual payment, mobile wallet, PayPal, Zelle, QuickPay, Google Pay, Apple Pay, etc. The payment may also include cryptocurrency payment, such as Bitcoin, Etherium, Dogecoin, etc. In various implementations, the mobile device 208 may determine that a digital payment transaction is detected in response to a payment made using a mobile wallet.

At 308, the gratuity payment system determines whether the digital payment transaction occurred at a predetermined location. The predetermined location may be determined from the GPS of the vehicle 204 and/or the mobile device 208. Additionally or alternatively, the predetermined location may be determined from one or more cameras or sensors that observe the exterior of the vehicle 204. The predetermined location may be a location that includes a separate area where gratuity is typically given. For example, the predetermined location may include a car wash, valet parking, curbside pickup at a grocery store or restaurant, etc. In the example that the predetermined location is a car wash, the car wash may offer towel drying services at an exit of the car wash; however, a digital payment transaction may have occurred at an entrance of the car wash. If the gratuity payment system determines that the digital payment transaction did not occur at the predetermined location, the digital payment transaction is concluded at 312.

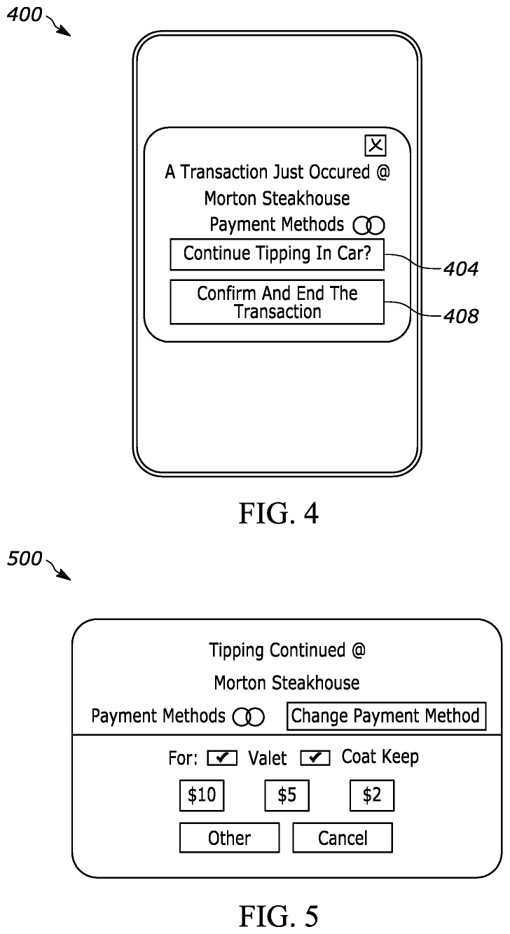

If the digital payment transaction did occur at the predetermined location, a prompt is displayed for the user or consumer at 316. The prompt may be displayed on the display (e.g., HMI) of the vehicle and/or on the mobile device. An example prompt 400 is shown in FIG. 4. The prompt 400 informs the user that a digital payment transaction occurred at a predetermined location, allowing the user to make a selection 404 to keep the digital payment transaction open or selection 408 to close the digital payment transaction. The prompt 400 may also include additional information, such as the form of payment used, the location of the digital payment transaction, etc.

Referring back to FIG. 3, at 320 the gratuity payment system determines whether the user agrees to keep the digital payment transaction open or not. If the user agrees to keep the digital payment transaction open (e.g., via selection 404), the digital payment transaction is kept open at 324. If the user agrees to close the digital payment transaction (e.g., via selection 408), the gratuity payment system concludes the digital payment transaction at 312.

At 328, the gratuity payment system determines whether the mobile device 208 is securely connected to the vehicle 204. The mobile device may be securely connected to the vehicle 104 when a wireless connection is established with the vehicle 204 using, for example, Bluetooth protocol. If the mobile device 208 is not securely connected to the vehicle 204, the gratuity payment system will wait until a secure connection is established at 332.

At 336, the user is shown an interface on the mobile device 208 and/or on the display (e.g., HMI) of the vehicle 204 for adding a gratuity. An example interface 500 is shown in FIG. 5. The interface 500 allows the user to select the amount of gratuity to be added to the digital payment transaction. The interface 500 may include additional information, such as the form of payment used, changing the form of payment for the gratuity, the location of the digital payment transaction, etc.

At 340, the user may select the gratuity to be added to the digital payment transaction. The user may select from a predetermined gratuity amount or may enter a custom amount. The predetermined gratuity may be recommended based on a percentage (e.g., 15%, 18%, or 20%) of the total amount of the digital payment transaction. Additionally or alternatively, the predetermined gratuity may be recommended based on the predetermined location. In the earlier example of the car wash, the predetermined gratuity may be a fixed amount, such as one dollar, two dollars, or three dollars.

At 344, the vehicle 204 may notify the person providing the service that a gratuity has been given them. The notification may include an audio notification played through external speakers of the vehicle 204 (e.g., chime), sounding a horn of the vehicle 204, etc. The notification may also include a visual notification, such as flashing exterior lights (e.g., headlights, turn signals, rear lamps) of the vehicle 104 with a pattern, lighting up other lights that are observable from the exterior of the vehicle 104, displaying text that is visible to an exterior of the vehicle 104, etc.

For example only, a use case of a vehicle car wash may explain the principles of the present disclosure. It is very common to pay for the car wash using a credit card or prepayment. At the end of the car wash, some services are provided in-person, such as towel drying, tire shinning, applying wax, vacuuming, etc. Generally, people pay a gratuity for these services. Due to the abundance of digital payment methods, there is either shortage of cash or change, resulting in not getting the services or being embarrassed of not providing a gratuity. In certain cases, such as dining in a restaurant, there is typically a mechanism to add a gratuity when a payment is made. However, there is no such system in the vehicle. Therefore, after the car wash or in a valet parking situation, the vehicle will prompt the user to pay a gratuity for the services received. A user may select the amount of gratuity to be added and the vehicle will send the amount digitally and communicate the same to the person providing the service by audiovisual cue.

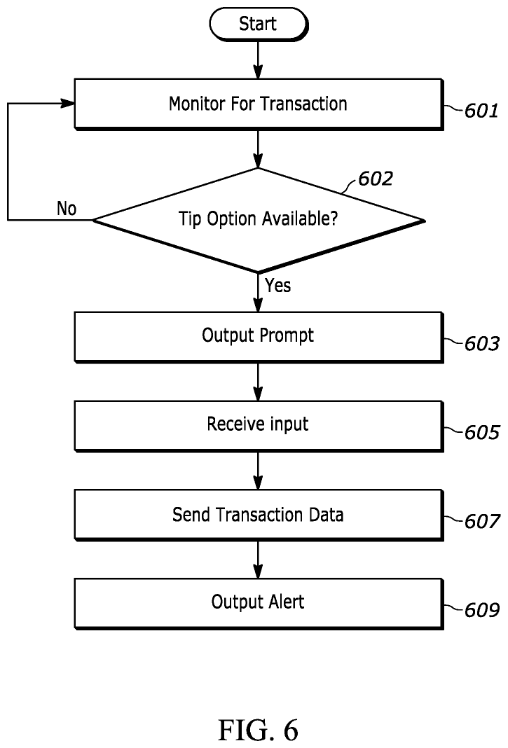

FIG. 6 is a flowchart of another embodiment of a tip occurring without a credit transaction. At step 601, the system may monitor for indications of a tip prompt at certain POIs. The POIs may be set by the user, and include various categories such as a car wash, restaurant, carry-out service, valet, hotel, etc. The monitoring may also utilize various sensors at the vehicle to identify such scenarios. At step 602, the system may determine that a tip option is available at a certain location. The system may utilize many different vehicle components to determine if a tip can occur. In one embodiment, a wireless transceiver of the vehicle computer system may be sent data from a POI that offers such a service. The POI may directly send the data to the vehicle via a transceiver at the POI (e.g., RFID or Bluetooth), or it may be sent by a remote server associated with the POI, and thus not located at the location offering the service. In another embodiment, the system may search for certain information to indicate a tip utilizing the vehicle sensors. For example, a QR code on a sign may be read by a camera of the vehicle. In another embodiment, an RFID reader or scanner may be in a vicinity to activate the tip prompt at the POI. In another example, the system may utilize image recognition to identify the word “TIP” or “TIP SERVICE” in an area. In yet another embodiment, the system may utilize multiple sensors to determine such completion of a maneuver that offers a tip. For example, the system may identify the start of a car wash when the vehicle is in neutral, moisture detector is found via the rain sensors, the wipers are turned off, and the proximity sensors go off. Upon completion of this scenario, the prompt may be initiated as being able to send a tip. If the system determines that the prompt is not to be output, it may simply continue to monitor for signals at step 601.

At 603, the system may output the prompt if it determines that a transaction option is available. The transaction option may include a tip option or payment for another type of service. The prompt may be similar to that of interface 500. The prompt may allow the user to select the amount of gratuity to be added to the digital payment transaction. The prompt may include additional information, such as the location of the digital payment transaction, the type of currency (e.g., cryptocurrency or digital currency, dollar, etc.), the form of payment used, changing the form of payment for the gratuity, etc.

At 605, the system may receive the input associated with the prompt. The input may include an amount to tip based on a dollar amount or percentage of a transaction/sale price. In a scenario that the user cancels the transaction, the system may simply continue to monitor for transactions at step 601. The input may be received at a user interface of the vehicle computer system, which may include a touch interface or a voice recognition system.

At 607, the system may send the transaction data and information. The transaction data and information may be sent to the POI directly via short-range communication (e.g., RFID, Bluetooth, or Wi-Fi, etc.). The transaction data and information may also be sent to a remote server via long-range communication (e.g., cellular signal, satellite, or other type of internet connection, etc.). The transaction may also be in coordination with a credit bureau, bank, crypto-wallet, or another authority to ensure availability of the tip value is ensured.

At 609, the system may output an alert to notify the user of outputting a tip was successfully sent. This may include activation of the vehicle horn, vehicle lights, and any other combination thereto. The activation of such components may notify the works that the driver did send a tip despite no cash being physically exchanged between occupants of the vehicle and workers. In another embodiment, the vehicle may initiate the sending of a signal to the POI via a transceiver at the POI to initiate activation of one or more components at the POI. This may include a sign being illuminated, a notification on a display at the POI, or sound being output via a speaker, bell, horn, etc. The vehicle may send instructions to a remote server or to the POI directly via a transceiver to indicate the alert. Thus, the service provider at the POI may understand that a tip was provided by the vehicle without any need for communication between people. The alert option may be simply an option and not required in all the transactions.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for utilizing vehicle connectivity to facilitate payment account transactions, the method comprising:
one or more wireless transceivers in communication with a remote server and mobile device;
a processor in communication with the wireless transceiver and transceiver, wherein the processor is programmed to:
identify a transaction option utilizing data sent to the vehicle computer system, wherein the data is associated with a point of interest (POI);
in response to identifying the transaction option, outputting a prompt on a vehicle display, the prompt including the transaction option; and
sending information regarding the transaction option to the remote server.

2. The computer-implemented method of claim 1, wherein the method further includes determining a secure connection between the vehicle and the mobile device.

3. The computer-implemented method of claim 2, wherein the method further includes waiting for the secure connection in response to determining the secure connection is not present between the vehicle and the mobile device.

4. The computer-implemented method of claim 2, wherein the method includes outputting an alert via a vehicle horn in response to sending the transaction to the server.

5. The computer-implemented method of claim 1, wherein the method further includes outputting a prompt to a second credit transaction in response to concluding a first credit transaction.

6. A vehicle computer system of a vehicle, comprising:
one or more wireless transceivers of the vehicle in communication with a remote server and mobile device;
a processor in communication with the wireless transceiver, wherein the processor is programmed to:
in response to one or more sensors of the vehicle identifying information, identify a transaction option utilizing data sent to the vehicle computer system, wherein the data is associated with a point of interest (POI); and
output a prompt on a vehicle display, the prompt including the transaction option; and
send information regarding the transaction option to the remote server.

7. The vehicle computer system of claim 6, wherein the processor is programmed to output the prompt to a second credit transaction via a mobile device display or a vehicle display.

8. The vehicle computer system of claim 6, wherein the processor is programmed to output the prompt in response to the one or more sensors identifying a QR code associated with the POI.

9. The vehicle computer system of claim 6, wherein the processor is programmed to output the prompt in response to the one or more sensors identifying text associated with the transaction option.

10. The vehicle computer system of claim 6, wherein the vehicle display includes a mobile device connected to the vehicle computer system.

11. The vehicle computer system of claim 6, wherein the system identifies the transaction option utilizing data associated with a point of interest and GPS location associated with the vehicle computer system.

12. The vehicle computer system of claim 6, wherein the processor is further programmed to output an alert via a vehicle horn in response to sending the transaction to the server.

13. A vehicle computer system of a vehicle, comprising:
one or more wireless transceivers in communication with a remote server and mobile device;
a processor in communication with the wireless transceiver and transceiver, wherein the processor is programmed to:
identify data initializing transactions sent to the vehicle computer system from the remote server; and
output a prompt including a transaction in response data associated with a point of interest (POI) and GPS location associated with the vehicle computer system, wherein the prompt to the transaction offers a tipping option, and sending the transaction to the server.

14. The vehicle computer system of claim 13, wherein the prompt includes a recommended tipping option utilizing statistical data associated with the POI.

15. The vehicle computer system of claim 13, wherein the remote server is associated with the POI.

16. The vehicle computer system of claim 13, wherein the processor is further programmed to output an alert via a vehicle horn in response to sending the transaction to the server.

17. The vehicle computer system of claim 13, wherein the processor is programmed to output the prompt in response to one or more vehicle sensors identifying a QR code associated with the POI.

18. The vehicle computer system of claim 13, wherein the processor is programmed to output the prompt in response to one or more vehicle sensors identifying text associated with the transaction option.

19. The vehicle computer system of claim 13, wherein the processor is further programmed to send instructions to the POI to output an alert.

20. The vehicle computer system of claim 13, wherein the vehicle computer system includes a one or more cameras configured to identify a sign proximate the vehicle and in response to the sign indicating information associated with a tipping option, output the prompt on the vehicle display.
